(19) United States
(12) Patent Application Publication
(10) Pub. No.: US 2012/0247768 A1
(43) Pub. Date: Oct. 4, 2012

(54) CROSSLINKING AGENTS FOR PRODUCING GELS AND POLYMER BEADS FOR OILFIELD APPLICATIONS

(75) Inventor: David Ballard, Aberdeenshire (GB)

(73) Assignee: M-I DRILLING FLUIDS UK LIMITED, Aberdeen (UK)

(21) Appl. No.: 13/499,467

(22) PCT Filed: Sep. 30, 2010
(86) PCT No.: PCT/GB10/51639

§ 371 Date: Jun. 18, 2012

(30) Foreign Application Priority Data
Sep. 30, 2009 (GB) 0917134.9

(51) Int. Cl. E21B 33/138; C08F 8/30; C09K 8/02; C09K 8/60; C08B 3/00; C11B 1/00

(52) U.S. Cl. 166/294; 536/32; 554/1; 507/111; 507/110; 507/138; 507/212; 507/211; 507/265; 525/330.5

(57) ABSTRACT

Embodiments disclosed herein relate to gels for use in downhole applications containing the reaction product of at least one polymer, or polymer precursor, and at least one oxazoline crosslinking agent, wherein the at least one polymer, or polymer precursor, and the oxazoline crosslinking agent are normally combined in a solution, and methods including the use thereof. Also disclosed is a method to activate the gel formation under acidic conditions thus improving gel control; oxazoline, aziridine and carbodiimide crosslinking agents

### BACKGROUND OF INVENTION

The present invention relates generally to methods for treating a wellbore, and more particularly, to crosslinking agents for producing gels and polymer beads used in treating the wellbore.

During the drilling of a wellbore, various fluids are typically used in the well for a variety of functions. The fluids may be circulated through a drill pipe and drill bit into the wellbore, and then may subsequently flow upward through wellbore to the surface. During this circulation, a drilling fluid may act to remove drill cuttings from the bottom of the hole to the surface, to suspend cuttings and weighting material when circulation is interrupted, to control subsurface pressures, to maintain the integrity of the wellbore until the well section is cased and cemented, to isolate the fluids from the formation by providing sufficient hydrostatic pressure to prevent the ingress of formation fluids into the wellbore, to cool and lubricate the drill string and bit, and/or to maximize penetration rate.

A common problem encountered during drilling operations is “lost circulation,” characterized by loss of drilling mud into downhole formations that are fractured, highly permeable, porous, cavernous, or vugular. The drilling fluids are either lost to the formation matrix or to voids in direct communication with the wellbore. Lost circulation is undesirable from an economic standpoint because it requires one to continually replenish the wellbore with costly drilling fluid. Lost circulation is also undesirable from an operational and safety standpoint because it can destabilize permeable formations and damage the pay zone, and in extreme cases it can result in a blowout of the hydrocarbon zone followed by a well fire.

Induced mud losses may also occur when the mud weight, required for well control and to maintain a stable wellbore, exceeds the fracture resistance of the formations. A particularly challenging situation arises in depleted reservoirs, in which the drop in pore pressure weakens hydrocarbon-bearing rocks, but neighbouring or inter-bedded low permeability rocks, such as shales, maintain their pore pressure. This can make the drilling of certain depleted zones impossible because the mud weight required to support the shale exceeds the fracture resistance of the sands and silts.

To combat such mud losses into the formation, lost circulation treatments are attempted to plug or block the openings either naturally formed or induced by the drilling operation. Such lost circulation treatments have included a variety of treatment materials, including polymeric based treatments having sufficient strength and integrity to minimize lost circulation into voids in direct communication with the wellbore, such as fractures, fracture networks, vugs, washouts, cavities, and the like.

In addition to troubles associated with mud loss, such polymeric based treatments may also be suitable for strengthening weakly or unconsolidated formation as a preventative measure. It is well known in the petroleum industry that some hydrocarbon-bearing formations are weakly consolidated or, in fact, may be unconsolidated formations. While such formations are known to contain substantial quantities of oil and gas, the production of oil and gas from these formations is difficult because of the movement of particulates such as sand particles and other finely divided particulate solids from the unconsolidated or weakly consolidated formation into the wellbore. This movement is a result of the movement of fluids and may be a result of the differential pressure between the formation and the wellbore created by pumping or by the production of fluids upwardly through the wellbore. Some formations are weakly consolidated or unconsolidated initially and others become weakly consolidated as a result of the production of fluids from the formation, especially when water is present in the produced fluid. Formations of this type are formations which are, at least in part, consolidated by the presence of clays in the formation. Such clays can become dispersed and expanded by the production of aqueous fluids from the formation, thereby weakening the overall formation to the point where it becomes unconsolidated or weakly consolidated with the resulting production of particulates into the wellbore. As a result, uncemented, weakly consolidated or unconsolidated formations impose limits on the draw-down pressure which can be used to produce fluids from the formation. This limits the rate at which fluids can be produced from the subterranean formation. To combat such problems associated with weakly or unconsolidated formations, treatments have been used to consolidate or strengthen the formation.

Similarly, treatments may also be used to reduce water production, i.e., water shut-off, through channelling in formation strata of relatively high permeabilities. The treatments may be used to correct channelling or change the injection profile in water flooding. Other situations arise in which isolation of certain zones within a formation may be beneficial. For example, one method to increase the production of a well is to perforate the well in a number of different locations, either in the same hydrocarbon bearing zone or in different hydrocarbon bearing zones, and thereby increase the flow of hydrocarbons into the well. The problem associated with producing from a well in this manner relates to the control of the flow of fluids from the well and to the management of the reservoir. For example, in a well producing from a number of separate zones (or from laterals in a multilateral well) in which one zone has a higher pressure than another zone, the higher pressure zone may disembogue into the lower pressure zone rather than to the surface. Similarly, in a horizontal well that extends through a single zone, perforations near the “heel” of the well, i.e., nearer the surface, may begin to produce water before those perforations near the “toe” of the well. The production of water near the heel reduces the overall production from the well.

In each of these scenarios, improved treatments for preventing mud loss, stabilizing and strengthening the wellbore, and zone isolation and water shutoff treatments are needed. In many wells, water-based and oil-based wellbore fluids are both used. Water-based wellbore fluids are generally used early in the drilling process. Later, oil-based wellbore fluids are substituted as the well gets deeper and reaches the limit of water-based wellbore fluids due to limitations such as lubricity and well bore stabilization.

### SUMMARY OF INVENTION

In one aspect, embodiments disclosed herein relate to methods of treating an earthen formation including injecting gel components comprising at least one polymer, or polymer precursor, and at least one oxazoline crosslinking agent; and allowing the gel components to react in the earthen formation.

In another aspect, embodiments disclosed herein relate to processes of strengthening a wellbore including injecting at least one polymer, or polymer precursor, into an earthen formation, injecting at least one oxazoline crosslinking agent into the earthen formation, and allowing the at least one polymer, or polymer precursor, and the at least one oxazoline crosslinking agent to react to form a gel.

In yet another aspect, embodiments disclosed herein relate to a gel for use in downhole applications comprising the reaction product of at least one polymer, or polymer precursor, and at least one oxazoline crosslinking agent.

In a further aspect embodiments disclosed herein relate to a method of treating an earthen formation comprising injecting gel components comprising at least one polymer, or polymer precursor, and at least one crosslinking agent selected from the group consisting of oxazoline, aziridine and carbodiimide, and allowing the gel components to react in the earthen formation at a pH of less than 7, preferably less than 5.

The reaction product of at least one polymer, or polymer precursor, and at least one oxazoline crosslinking agent may be provided in, or in the form of, polymer beads which swell when injected into the earthen formation.

Preferably the polymer, or polymer precursor, and crosslinking agent are provided in a solution.

Such gels may be formed downhole by injection and reaction of the components in the wellbore, or may be formed from the swelling of preformed polymer beads downhole comprising the reaction product of at least one polymer, or polymer precursor, and at least one oxazoline crosslinking agent. The inventor has surprisingly found that polymers may be crosslinked with oxazoline crosslinking agents to form gels or polymer beads suitable for use in treating earthen formations.

### Gels

Gels are solid, jelly-like materials formed from colloidal solutions of crosslinked gelling agents. The gel typically contains about 99 wt. % liquid which is immobilized by surface tension in a macromolecular network of fibres built from a small amount of crosslinked gelling agent present. For example, gelling agents such as crosslinkable polymers may be crosslinked by oxazoline crosslinking agents to form a gel in some embodiments disclosed herein. The resulting gel is a polymeric network consisting of interconnected macromolecules which expand in all three dimensions. By weight, gels are mostly liquid, yet they behave like solids. In addition, gels may have unique properties such as thixotropy, where they become fluid when agitated, but resolidify when resting.

In some embodiments, the crosslinkable polymers may be dissolved or dispersed in a fluid such as water, and an oxazoline crosslinking agent may be added to the fluid, reacting with the polymers to form a gel. For certain embodiments the pH of the solution may be adjusted to enhance gel formation. The gel may be used in downhole applications as a component of drilling mud and may be preformed and pumped downhole. Preferably however, the components may form the gel in situ and this may be achieved through sequential introduction downhole, or by using polymers and crosslinking agents which react at a sufficiently slow rate so that they may be added concurrently but only gel after a delay and so only when in the earthen formation. In preferred embodiments, the slightly acidic pH in the earthen formation causes the polymer and crosslinker to gel.

Alternatively, preformed discrete polymer beads of oil-soluble or dispersible polymers crosslinked by oxazoline crosslinking agents may be dispersed in a wellbore fluid and pumped downhole. Such polymer beads may be formed from a solution, suspension or emulsion of crosslinked polymers. However, beads may also be formed by forming (on the surface) a polymer network, and cutting such network into smaller discrete beads (which may be optionally dehydrated prior pumping downhole). The polymer beads may absorb water, and swell, and may therefore be considered super absorbent polymers. For example, crosslinkable polymers may be crosslinked by oxazoline crosslinking agents in a solution to form discrete soft elastic beads in some embodiments disclosed herein. The resulting polymer bead is a crosslinked polymeric network consisting of interconnected macromolecules which expand in all three dimensions.

In some embodiments, the crosslinkable polymers may be dissolved or dispersed in a fluid such as water, and an oxazoline crosslinking agent may be added to the fluid, reacting with the polymers to form polymer beads. The polymer beads may be used in downhole applications as a component of drilling mud and may be preformed by a separate process and pumped downhole. Alternatively, the components may be introduced sequentially downhole forming the polymer beads in situ.

Polymer beads provide the advantage of being removable, if necessary, from the flow paths connecting a wellbore to the production zone of a penetrated formation. Further, polymer beads produced in situ or by a separate process may be used for various applications such as lost circulation, water shutoff treatment, or other uses in subterranean wells.

### Polymers

In one embodiment, the gel may be formed from a polymer which is capable of being chemically crosslinked to form a polymeric gel structure. Precursors of polymers may also be used, such as oligomers or polymers.

Such polymers may have at least one, preferably two or more oxazoline reactive groups. Polymers having at least one functional oxazoline reactive group may crosslink to effectively form a gel network. For example, the polymer may possess carboxyl functional groups, phenol or thiol functional groups or derivatives thereof. However, there is no limitation on the types or combinations of functional groups possessing an oxazoline reactive group that may be present in a polymer used in embodiments disclosed herein. A polymer containing a functional group with an oxazoline reactive group may serve as the reactive nucleophile for crosslinking with an appropriate electrophile, such as an oxazoline group. The oxazoline group reacts with the oxazoline reactive group of the polymer. Each oxazoline group can react with an oxazoline reactive group. Multifunctional oxazoline crosslinking agents may thereby crosslink polymers to form the gels of the present disclosure.

In some embodiments, the suitable polymers may comprise natural polymers and oligomers, such as starch, carboxymethylcellulose, guar, and derivatives thereof. Natural starches may include those of potato, wheat, tapioca, rice, corn, and roots having a high starch content, among others. For example the carboxymethylcellulose may be obtained from the product POLYPAC ELV sold by M-I SWACO. Chemically modified starches may also be used and these include carboxymethyl starch, hydroxyethyl starch, hydroxypropyl starch, acetate starch, sulfamate starch, phosphate starch, and nitrogen modified starch, among others.

In other embodiments, suitable polymers may comprise dimer or trimer acids of natural oils such as soybean oil, linseed oil, rapeseed oil, cashew nut shell oil, perilla oil, tung oil, oiticia oil, safflower oil, poppy oil, hemp oil, cottonseed oil, sunflower oil, high-oleic triglycerides, triglycerides of euphorbia plants, peanut oil, olive oil, olive kernel oil, almond oil, kapok oil, hazelnut oil, apricot kernel oil, beechnut oil, lupin oil, maize oil, sesame oil, grapeseed oil, lallemantia oil, castor oil, herring oil, sardine oil, menhaden oil, whale oil, tall oil, and derivatives thereof.

In further embodiments, the polymers may include lignins, lignosulfonates, tannins, tannic acids, and combinations thereof. In other embodiments, materials to be crosslinked may include modified lignins, modified lignosulfonates, modified tannins, modified tannic acids, and combinations thereof. In certain embodiments, tannins may be modified to have a higher phenol content. In certain other embodiments, tannins may be treated with amines.

In yet other embodiments, suitable polymers may comprise various synthetic compounds such as carboxylic acids, acrylates, and oligomers and polymers thereof. In one embodiment, the polymer may be a synthetic acrylate polymer sold under the brand IDCAP D by M_I Swaco

In other embodiments, polymers may include biopolymers, starches, polyacrylamides, and combinations thereof.

In another embodiment, the polymer may be an oil soluble dimer acid, such as those commercially available under the trade name UNIDYME® from Arizona Chemical (Jacksonville, Fla.). In yet another embodiment, the polymer may be a low molecular weight oil-soluble acrylate-based polymer, such as those commercially available under the trade name EMI 759 from M-I SWACO (Houston, Tex.).

### Other Polymers

Whist the present invention particularly elate to the use of oxazoline crosslinking agents, certain embodiments of the invention may also use aziridine and carbodiimide crosslinking agents and allowing the gel components to react in the earthen formation at a pH of less than 7, preferably less than 5.

With respect to embodiments including aziridine and carbodiimide crosslinking agents, the gel may be formed from other polymers, described below, which are capable of being chemically crosslinked to form a polymeric structure. Such polymers may have at least one, preferably two or more functional groups possessing abstractable or “active” hydrogens. Polymers having at least one functional group possessing active hydrogens may crosslink to effectively form a gel network. For example, the polymer may possess carboxyl functional groups, primary or secondary amine functional groups, primary or secondary amide functional groups, alcohol functional groups, imine functional groups or derivatives thereof. However, there is no limitation on the types or combinations of functional groups possessing an active hydrogen that may be present in a polymer used in embodiments disclosed herein. A polymer containing a functional group with an active hydrogen may serve as the reactive nucleophile for crosslinking with an appropriate electrophile, such as an aziridine group. The aziridine group reacts with the active hydrogen of the functional groups of the polymer. Each aziridine group can react with an active hydrogen. Multifunctional aziridine (or carbodiimide) crosslinking agents may thereby crosslink polymers to form the gels of the present disclosure.

In some embodiments, the suitable polymers may comprise natural polymers and oligomers, such as starch, carboxymethylcellulose, guar, and derivatives thereof. Natural starches may include those of potato, wheat, tapioca, rice, corn, and roots having a high starch content, among others. For example the carboxymethylcellulose may be obtained from the product POLYPAC ELV sold by M-I SWACO. Chemically modified starches may also be used and these include carboxymethyl starch, hydroxyethyl starch, hydroxypropyl starch, acetate starch, sulfamate starch, phosphate starch, and nitrogen modified starch, among others.

In other embodiments, suitable polymers may comprise various natural oils such as soybean oil, linseed oil, rapeseed oil, cashew nut shell oil, perilla oil, tung oil, oiticia oil, safflower oil, poppy oil, hemp oil, cottonseed oil, sunflower oil, high-oleic triglycerides, triglycerides of euphorbia plants, peanut oil, olive oil, olive kernel oil, almond oil, kapok oil, hazelnut oil, apricot kernel oil, beechnut oil, lupin oil, maize oil, sesame oil, grapeseed oil, lallemantia oil, castor oil, herring oil, sardine oil, menhaden oil, whale oil, tall oil, and derivatives thereof.

In further embodiments, the polymers may include lignins, lignosulfonates, tannins, tannic acids, and combinations thereof. In other embodiments, materials to be crosslinked may include modified lignins, modified lignosulfonates, modified tannins, modified tannic acids, and combinations thereof. In certain embodiments, tannins may be modified to have a higher phenol content. In certain other embodiments, tannins may be treated with amines.

In yet other embodiments, suitable polymers may comprise various synthetic compounds such as carboxylic acids, acrylates, acrylamides, urethanes, and oligomers and polymers thereof. In one embodiment, the polymer may be a synthetic acrylate polymer sold under the brand IDCAP D by M_I Swaco

In other embodiments, polymers may include biopolymers, starches, polyacrylamides, and combinations thereof. In other embodiments, polymers may include polyamines such as diethylene triamine and triethylene tetramine, and the like. In yet other embodiments, polymers may include alloxylated amines, poly vinyl amines and polyethylene imines.

In another embodiment, the polymer may be an oil soluble dimer acid, such as those commercially available under the trade name UNIDYME® from Arizona Chemical (Jacksonville, Fla.). In yet another embodiment, the polymer may be a low molecular weight oil soluble acrylate-based polymer, such as those commercially available under the trade name EMI 759 from M-I SWACO (Houston, Tex.).

### Oxazoline Crosslinking Agents

An oxazoline is an unsaturated heterocyclic compound containing a five-membered ring, with nitrogen and oxygen heteroatoms or any derivative thereof.

Typically the oxygen and nitrogen are provided in the 1, 3 positions of the heterocycle; that is typically they are spaced apart by a single C atom within the heterocycle.

Preferably at least one of the N and O in the heterocycle are attached to a neighbouring C in the ring by a double bond; preferably nominally the N is so attached by a double bond. Preferably the N or O which is attached by a double bond, is attached to the carbon atom in the 2 position. However, the N—C—O group does not typically include a discrete single and double bond, but rather delocalised π-electrons in additional to two single bonds connecting the N and C and C and O respectively.

Thus preferably the oxazoline group has the structure:

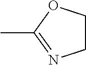

Oxazoline groups undergo a reaction with various groups according to the equations below:

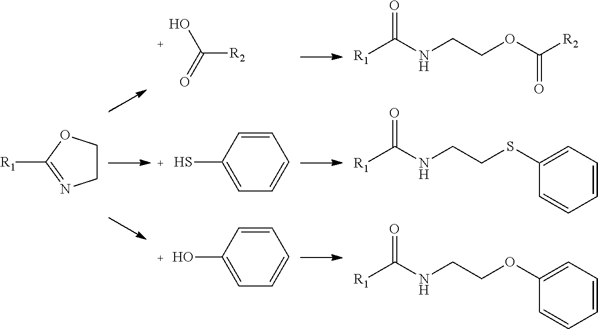

In particular oxazoline groups react with carboxyl groups as illustrated below:

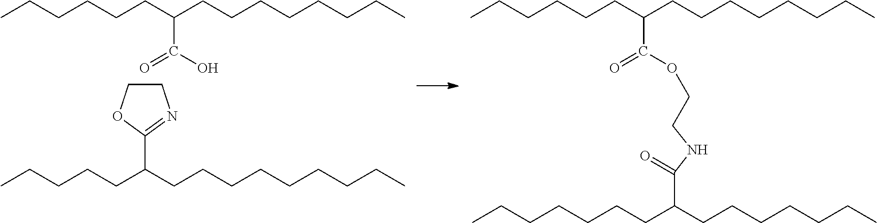

Oxazoline compounds may be used as crosslinkers in embodiments disclosed herein, and may be capable of being emulsified or dissolved. These oxazoline crosslinking agents may be bifunctional, trifunctional, or polyfunctional, having two, three, or n oxazoline functional groups per molecule.

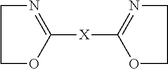

wherein X is saturated or unsaturated aliphatic or cycloaliphatic radical having from 0 to 60 carbon atoms or an araliphatic or aromatic radical having from 6 to 60 carbon atoms, where X may be contain carboxyl and amide groups. Where X is 0 the two rings are connected directly and 2-(4,5-dihydrooxazol-2-yl)-4,5-dihydrooxazole is formed.

The class of oxazoline crosslinking agents useful herein is extremely broad, ranging from simple compounds to very complex compounds. Some examples of oxazoline crosslinking agents useful in embodiments disclosed herein are represented below.

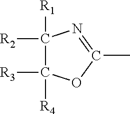

wherein R₁, R₂, R₃ and R₄ are independently an H atom, an alkyl group, an aromatic group, a substituted alkyl group, a substituted aromatic group or a halogen.

Examples of these compounds are 2-(1,3-oxazolin-2-yl)-1,3-oxazoline, bis(1,3-oxazolin-2-yl)-1,4-phenylene and bis(1,3-oxazolin-2-yl)-1,4-butane, which are obtainable by reacting dicarboxylic esters with aminoethanol, followed by dehydration in sulfuric acid.

Preferred bisoxazolines are those of the formula:

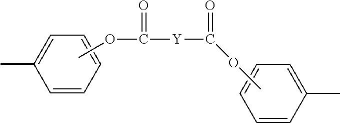

where Y is a hydrocarbon radical having from 1 to 24 carbon atoms.

One such compound is

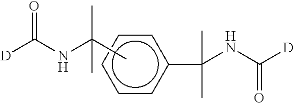

where D is

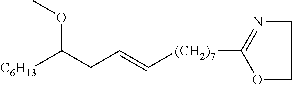

which is obtainable by reacting ricinus-2-oxazoline with tetra-methylxylene diisocyanate (see B. Birnbrich et al., Kunststoffe 83 (1993), p. 885-888).

One suitable supplier of oxazoline compounds is Nippon Shokubai (www.shokubai.co.jp). One suitable product is available from Nippon Shokubai under the brand name EPOCROS. A preferred oxazoline is EPOCROS W700.

The crosslinker may be present in an amount effective to crosslink the polymer. In some embodiments, the crosslinker may be used in an amount ranging from about 0.05 to about 50 weight percent based on the total weight of the polymer(s). In other embodiments, the crosslinker may be used in an amount ranging from about 5 to about 40 weight percent based on the total weight of the polymer(s); from about 10 to about 35 weight percent in yet other embodiments. In other embodiments, a weight ratio of the crosslinker to the polymer may be from 1:2000 to 1:1; from 1:20 to 1:2 in other embodiments, and from 1:10 to about 1:3 in yet other embodiments.

The amount of crosslinker may affect the hardness of the resulting gel. For example, in some embodiments, for a constant weight of polymer, increasing the amount of crosslinker may result in a higher crosslinking density, and therefore a harder gel. Using the guidelines provided herein, those skilled in the art will be capable of determining a suitable amount of crosslinker to employ to achieve a gel of the desired hardness.

### Other Crosslinking Agents

Whilst preferred embodiments of the present invention use gel components comprising oxazoline crosslinking agents, the inventor of the present invention has discovered that aziridine and carbodiimide crosslinking agents as well as oxazoline crosslinking agents will gel in formation when they encounter an acidic pH. This provides the advantage of more control of the gelling step so that it is more likely to occur when the gel components are deep in formation rather than occur prematurely.

Aziridine crosslinking agents are a group of organic compounds which contain the 2-methylaziridine functional group. The 2-methylaziridine functional group has a molecular formula of C₂H₅N, and is a three-membered heterocycle containing one amine group and two methylene groups. Aziridine compounds function as excellent crosslinking agents due to the extreme ring strain observed in this molecule. The structure of the aziridine functional group is represented below. The R group represents the rest of the aziridine compound, and may be any of H, an aliphatic group, an aromatic group, or a cycloaliphatic group.

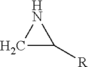

Aziridine compounds may be used as crosslinkers in embodiments disclosed herein, and may be capable of being emulsified. These aziridine crosslinking agents may be bifunctional, trifunctional, or polyfunctional, having two, three, or n aziridine functional groups per molecule, as represented by the structures below. The R, R₁, and R₂ groups represent the rest of the aziridine compound, and may the same or different from each other. The R groups may be any of an aliphatic group, an aromatic group, or a cycloaliphatic group.

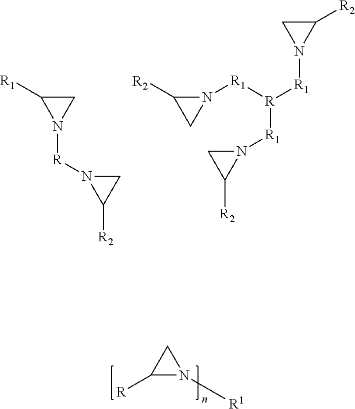

The class of aziridine crosslinking agents useful herein is extremely broad, ranging from simple compounds to very complex compounds. Some examples of aziridine crosslinking agents useful in embodiments disclosed herein are represented below.

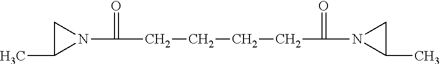

### N,N′-Bis-propylenadipic acid amide (BPA)

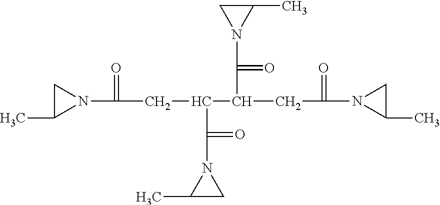

### N,N′,N″,N′″-Tetrapropylen-1,2,3,4-butanetetracarbonic acid amide

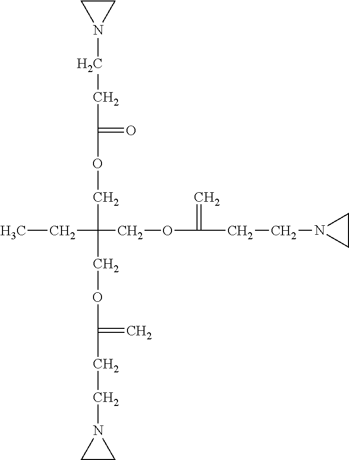

### Trimethylolpropane-tris(β-(N-aziridinyl)propionate)

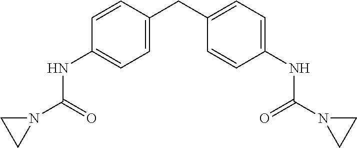

### N,N′-(methylenedi-p-phenylene)bis(aziridine-1-carboxamide)

In one embodiment, the aziridine crosslinking agent may an aromatic aziridine such as N,N′-(methylenedi-p-phenylene)bis(aziridine-1-carboxamide), which is an bifunctional aromatic aziridine crosslinking agent and is commercially available under the trade name Icaplink X5 from ICAP-SIRA Chemicals and Polymers (Italy). In another embodiment, the aziridine crosslinking agent may be an aliphatic aziridine crosslinking agent such as trimethylolpropane-tris(β-(N-aziridinyl)propionate), which is an trifunctional aliphatic azirine and is commercially available under the trade name Corial® from BASF (Germany). In yet another embodiment, the aziridine crosslinking agent may be a polyfunctional aliphatic aziridine crosslinking agent having the molecular formula C₂₀H₃₃O₇N₃, which is commercially available under the trade name XAMA® 7 from Ichemco (Italy).

A polycarbodiimide crosslinking agent is a molecule containing two or more carbodiimide functional groups, —N═C═N—. The reaction between a carbodiimide and an active hydrogen compound proceeds by the addition of the active hydrogen bond to one of the carbon-nitrogen double bonds as shown below:

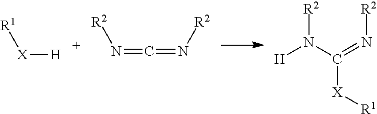

However, the type of active hydrogen compound may have some bearing on whether any further reaction occurs. Specifically, for a carboxylic acid reacting with a carbodiimide, upon the addition reaction between the carbodiimide and the carboxylic acid, the following the addition reaction may result in a less stable O-isoacylurea, which may then rearrange to form a more stable N-acylurea, as shown below:

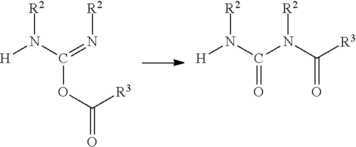

Further due to the formation of the less stable intermediate, O-isoacylurea, it is possible that such intermediate may react with any available amines or carboxylic acids, for example, to form amides or acid anhydrides, respectively, with urea by products.

Thus, as described above, a polycarbodiimide compound is a carbodiimide compound containing at least two carbodiimide groups, i.e. —N═C═N— within the molecule. Such polycarbodiimide compounds may be used alone or two or more of them may be used in combination. Such polycarbodiimide compounds containing two or more carbodiimide groups may be formed by subjecting a polyisocyanate compound (containing at least two isocyanate groups) to decarboxylation in an organic solvent in the presence of a carbodiimide formation catalyst.

Examples of such polyisocyanates which may be used include aliphatic, alicyclic, aromatic or araliphatic diisocyanate compounds. Aliphatic polyisocyanates may include hexamethylene diisocyanate, trimethylhexamethylene diisocyanate, dimeric acid diisocyanate, lysine diisocyanate and the like, and biuret-type adducts and isocyanurate ring adducts of these polyisocyanates. Alicyclic diisocyanates may include isophorone diisocyanate, 4,4′-methylenebis(cyclohexylisocyanate), methylcyclohexane-2,4- or -2,6-diisocyanate, 1,3- or 1,4-di(isocyanatomethyl)cyclohexane, 1,4-cyclohexane diisocyanate, 1,3-cyclopentane diisocyanate, 1,2-cyclohexane diisocyanate, and the like, and biuret-type adducts and isocyanurate ring adducts of these polyisocyanate. Aromatic diisocyanate compounds may include xylylene diisocyanate, metaxylylene diisocyanate, tetramethylxylylene diisocyanate, tolylene diisocyanate, 4,4′-diphenylmethane diisocyanate, 1,5-naphthalene diisocyanate, 1,4-naphthalene diisocyanate, 4,4′-toluydine diisocyanate, 4,4′-diphenyl ether diisocyanate, m- or p-phenylene diisocyanate, 4,4′-biphenylene diisocyanate, 3,3′-dimethyl-4,4′-biphenylene diisocyanate, bis(4-isocyanatophenyl)-sulfone, isopropylidenebis(4-phenylisocyanate), and the like, and biuret type adducts and isocyanurate ring adducts of these polyisocyanates. Polyisocyanates having three or more isocyanate groups per molecule may include, for example, triphenylmethane-4,4′,4″-triisocyanate, 1,3,5-triisocyanato-benzene, 2,4,6-triisocyanatotoluene, 4,4′-dimethyldiphenylmethane-2,2′,5,5′-tetraisocyanate, and the like, biuret type adducts and isocyanurate ring adducts of these polyisocyanates. Additionally, isocyanate compounds used herein may include urethanation adducts formed by reacting hydroxyl groups of polyols such as ethylene glycol, propylene glycol, 1,4-butylene glycol, dimethylolpropionic acid, polyalkylene glycol, trimethylolpropane, hexanetriol, and the like with the polyisocyanate compounds, and biuret type adducts and isocyanurate ring adducts of these polyisocyanates.

Other isocyanate compounds may include tetramethylene diisocyanate, toluene diisocyanate, hydrogenated diphenylmethane diisocyanate, hydrogenated xylylene diisocyanate, and trimers of these isocyanate compounds; terminal isocyanate group-containing compounds obtained by reacting the above isocyanate compound in an excess amount and a low molecular weight active hydrogen compounds (e.g., ethylene glycol, propylene glycol, trimethylolpropane, glycerol, sorbitol, ethylenediamine, monoethanolamine, diethanolamine, triethanolamine etc.) or high molecular weight active hydrogen compounds such as polyesterpolyols, polyetherpolyols, polyamides and the like may be used in embodiments disclosed herein.

Other useful polyisocyanates include, but are not limited to 1,2-ethylenediisocyanate, 2,2,4- and 2,4,4-trimethyl-1,6-hexamethylenediisocyanate, 1,12-dodecandiisocyanate, omega, omega-diisocyanatodipropylether, cyclobutan-1,3-diisocyanate, cyclohexan-1,3- and 1,4-diisocyanate, 2,4- and 2,6-diisocyanato-1-methylcyclohexane, 3-isocyanatomethyl-3,5,5-trimethylcyclohexylisocyanate (“isophoronediisocyanate”), 2,5- and 3,5-bis-(isocyanatomethyl)-8-methyl-1,4-methano, decahydronaphthathalin, 1,5-, 2,5-, 1,6- and 2,6-bis-(isocyanatomethyl)-4,7-methanohexahydroindan, 1,5-, 2,5-, 1,6- and 2,6-bis-(isocyanato)-4,7-methanohexahydroindan, dicyclohexyl-2,4′- and -4,4′-diisocyanate, omega, omega-diisocyanato-1,4-diethylbenzene, 1,3- and 1,4-phenylenediisocyanate, 4,4′-diisocyanatodiphenyl, 4,4′-diisocyanato-3,3′-dichlorodiphenyl, 4,4′-diisocyanato-3,3′methoxy-diphenyl, 4,4′-diisocyanato-3,3′-diphenyl-diphenyl, naphthalene-1,5-diisocyanate, N—N′-(4,4′-dimethyl-3,3′-diisocyanatodiphenyl)-uretdion, 2,4,4′-triisocyanatano-diphenylether, 4,4′,4″-triisocyanatotriphenylmethant, and tris(4-isocyanatophenyl)-thiophosphate.

Other suitable polyisocyanates may include: 1,8-octamethylenediisocyanate; 1,11-undecane-methylenediisocyanate; 1,12-dodecamethylendiisocyanate; 1-isocyanato-3-isocyanatomethyl-3,5,5-trimethylcyclohexane; 1-isocyanato-1-methyl-4(3)-isocyanatomethylcyclohexane; 1-isocyanato-2-isocyanatomethylcyclopentane; (4,4′- and/or 2,4′-)diisocyanato-dicyclohexylmethane; bis-(4-isocyanato-3-methylcyclohexyl)-methane; a,a,a′,a′-tetramethyl-1,3- and/or -1,4-xylylenediisocyanate; 1,3- and/or 1,4-hexahydroxylylene-diisocyanate; 2,4- and/or 2,6-hexahydrotoluene-diisocyanate; 2,4- and/or 2,6-toluene-diisocyanate; 4,4′- and/or 2,4′-diphenylmethane-diisocyanate; n-isopropenyl-dimethylbenzyl-isocyanate; any double bond containing isocyanate; and any of their derivatives having urethane-, isocyanurate-, allophanate-, biuret-, uretdione-, and/or iminooxadiazindione groups.

Polyisocyanates may also include aliphatic compounds such as trimethylene, pentamethylene, 1,2-propylene, 1,2-butylene, 2,3-butylene, 1,3-butylene, ethylidene and butylidene diisocyanates, and substituted aromatic compounds such as dianisidine diisocyanate, 4,4′-diphenylether diisocyanate and chlorodiphenylene diisocyanate.

Other isocyanate compounds are described in, for example, U.S. Pat. Nos. 6,288,176, 5,559,064, 4,637,956, 4,870,141, 4,767,829, 5,108,458, 4,976,833, and 7,157,527, U.S. Patent Application Publication Nos. 20050187314, 20070023288, 20070009750, 20060281854, 20060148391, 20060122357, 20040236021, 20020028932, 20030194635, and 20030004282, each of which is hereby incorporated by reference. Isocyanates formed from polycarbamates are described in, for example, U.S. Pat. No. 5,453,536, hereby incorporated by reference herein. Carbonate isocyanates are described in, for example, U.S. Pat. No. 4,746,754, hereby incorporated by reference herein.

Further, no limitation on the type of polyisocyanate compound from which a polycarbodiimide may be derived is intended to be placed on the gels of the present disclosure. It is also appreciated that one or more polyisocyanates may be used in accordance with some embodiments of the present disclosure.

Additionally, in the decarbonation condensation reaction between the one or more polycarbodiimides, it may also be desirable to include a monofunctional water-soluble or dispersible organic compound of component to impart solubility or dispersibility in water to the polycarbodiimide compound being formed, depending on the type of gel desired to be formed (aqueous gel or non-aqueous gel). The compound should be one which has monofunctionality and can react with the terminal isocyanate groups of the polycarbodiimide compound derived from the isocyanate as discussed above to block the terminal groups. Such water-soluble or water-dispersible organic compounds may be any compounds which have one group capable of reacting with an isocyanate group, e.g., a hydroxyl group, carboxylic acid group, amine group or sulfonyl group, and which are soluble or dispersible in water. Thus, for example, such compounds may include monoalkyl esters and monoalkyl ethers of bifunctional, water-soluble or water-dispersible organic compounds having preferably OH groups at terminal ends thereof, e.g., polyethylene glycol, polypropylene glycol and the like, and monofunctional organic compounds having a cationic functional group (e.g., a group containing nitrogen) or an anionic functional group (e.g., a group containing a sulfonyl group). Specific examples may include polyethylene glycol monomethyl ether, polypropylene glycol monomethyl ether, and the like. Alternatively, where hydrophilicity is not desired, one skilled in the art would appreciate that a monoisocyanate may be used at the terminal ends of the carbodiimide, and that such ends may also be blocked with blocking agents, as known in the art.

Organic solvents which may be used to form such carbodiimides are ones having a high boiling point and having no active hydrogen atom reactive with the isocyanate compound or the carbodiimide group-containing compound formed. Specifically, such solvents may include aromatic hydrocarbons such as toluene, xylene and diethylbenzene; glycol ether esters such as diethylene glycol diacetate, dipropylene glycol dibutyrate, hexylene glycol diacetate, glycol diacetate, methylglycol acetate, ethylglycol acetate, butylglycol acetate, ethyldiglycol acetate and butyldiglycol acetate; ketones such as ethyl butyl ketone, acetophenone, propiophenone, diisobutyl ketone and cyclohexanone; and aliphatic esters such as amyl acetate, propyl propionate, ethyl butyrate, and the like may be used alone or in combination. Furthers, examples of carbodiimide formation catalyst may include any known in the art, including phospholenes, phospholene oxides and so forth. U.S. Pat. Nos. 5,958,516, 6,124,398, 5,688,875, and 5,360,933 disclose the synthesis and use of various carbodiimides, which are herein incorporated by reference in their entirety. Further, examples of commercially available polycarbodiimides that may be used as crosslinking agents include those sold under the trade name Carbodilite V-Series from Nisshinbo Industries, Inc. (Chiba, Japan).

### Gel/Bead Preparation

In various embodiments, the polymers and/or the oxazoline crosslinking agents may be used in their neat form, may be dissolved in a solvent such as water, or may be dissolved, dispersed or emulsified in a non-miscible phase, to form a gel or elastic beads. For example, a gel or bead may be formed by mixing the polymers with the oxazoline crosslinking agent in water. Solvents that may be appropriate may comprise water-based or oil-based muds for use in downhole applications and may include mineral oil, diesel, and synthetic oils; fresh water, sea water, brine based fluids including KCl, CaCl₂.

In particular embodiments, the oxazoline crosslinking agents and/or the polymers may be emulsified in a non-miscible phase. Emulsification of the oxazoline crosslinking agent and/or the polymers in a non-miscible solvent may allow for optimal dispersion of the oxazoline crosslinking agent. Optimal dispersion of the oxazoline crosslinking agent may promote the formation of a fairly uniform gel or bead. A uniform gel or bead structure is desirable, in part because it allows greater predictability of gel or bead properties such as hardness, flexibility, and strength. Further, in some embodiments, depending on the chemistry of the polymer selected, the oxazoline crosslinking agent may be emulsified in the solvent, and the emulsion stabilized by the polymer.

The type of oxazoline crosslinking agent selected as the crosslinking agent will affect the properties of the resulting gel or bead. For example, selection of a polyfunctional oxazoline crosslinking agent may affect the extent of crosslinking achieved. For example, selection of a trifunctional oxazoline crosslinking agent may result in a denser gel or bead as compared to a gel or bead comprising a bifunctional oxazoline crosslinking agent. Further, the molar equivalent ratio of the polymer (LM) to the selected oxazoline crosslinking agent (OCA) will also affect the extent of crosslinking achieved. Given the molar equivalent ratio of LM:OCA, one can determine the proper molar equivalent ratio to obtain a desired gel or bead possessing a desired density and hardness. For instance, the LM:OCA ratio may be selected for low crosslinking that may lead to more flexible gel or bead structures. In other embodiments, the LM:OCA ratio may be selected for higher crosslinking that may lead to harder gel or bead structures.

The optimal ratios for the polymer and oxazoline crosslinking agents may vary depending on the exact structures and desired properties of the gel or bead. For instance, the weight ratio of polymer to oxazoline crosslinking agent may vary from a range of about 35:1 to about 5:1, and from about 2:1 to 1:1.5, and from about 1.2:1 to 1:1.2. The amount of oxazoline crosslinking agent may affect the hardness of the resulting gel or bead. For example, in some embodiments, for a constant weight of polymer, increasing the amount of oxazoline crosslinking agent may result in higher crosslinking density, and therefore a harder gel or bead.

The optimal volume of the oxazoline crosslinking agent relative to the total volume of the gel or bead may vary depending upon the desired properties of the gel or bead. For example, the volume percent of the oxazoline crosslinking agent relative to the total volume of the gel or bead comprises approximately 10 to 40 percent by volume. In other embodiments, the volume percent of the oxazoline crosslinking agent relative to the total volume of the gel or bead is approximately 15 to 30 percent by volume.

The oxazoline crosslinking agent may be modified to control the rate of crosslinking. For example, the oxazoline crosslinking agent may be immobilized on an inert support. In other particular embodiments, the oxazoline crosslinking agent may be encapsulated by a material that may retard that rate of reaction. Removal of this encapsulation at the desired time may be achieved by any means known in the art, for example chemical removal. The timing of the crosslinking reaction may therefore be controlled by such modifications.

### Aging Temperature

In some embodiments, the polymer and the oxazoline crosslinking agent may be reacted at a temperature from −50 to 300° C. In other embodiments, the polymer and the crosslinking agent may be reacted at a temperature from 25 to 250° C.; from 50 to 150° C. in other embodiments; and from 60 to 100° C. in yet other embodiments. In certain embodiments, the reaction temperature determines the amount of time required for gel or bead formation.

### Time Required for Gel or Bead Formation

Embodiments of the gels or beads disclosed herein may be formed by mixing a polymer with an oxazoline crosslinking agent. In some embodiments, a gel or beads may form immediately upon mixing the polymer and the oxazoline crosslinking agent. In other embodiments, a gel or beads may form within 1 minute of mixing; within 5 minutes of mixing in other embodiments; within 30 minutes of mixing in other embodiments. In some embodiments, a gel or beads may form within 1 hour of mixing; within 8 hours in other embodiments; within 16 hours in other embodiments; within 80 hours in other embodiments; within 120 hours in yet other embodiments.

pH

In some embodiments, the oil soluble or oil dispersible polymer and the crosslinking agent may be reacted in a medium having a pH greater than 4. In other embodiments, they may be reacted in a medium having a pH greater than 6; a pH greater than 7 in other embodiments; a pH greater than 8 in other embodiments; a pH greater than 9 in yet other embodiments.

Reagents which may be used to adjust the pH may include alkali metal hydroxides, such as sodium hydroxide, potassium hydroxide, calcium hydroxide, and rubidium hydroxide, lithium hydroxides, benzyltrimethylammonium hydroxides, and the partially neutralized salts of organic acids, such as tri-sodium ethylenediaminetetraacetic acid. In some embodiments, the alkali metal hydroxide, pH adjusting agent, or buffer, may act as a catalyst, effecting or enhancing the crosslinking reaction between the polymer and the crosslinking agent.

However in preferred embodiments the slightly alkaline pH is used to delay the cross-linking reaction as required. This is because preferred embodiments are activated to form the gel, by reaction between the crosslinker and polymer, by slightly acidic conditions. This is an important aspect of certain embodiments, since earthen formations are often slightly acidic due to the presence of carbon dioxide. Thus, for such embodiments, this can provide very useful control of the polymer/crosslinking reaction, such that the polymer and crosslinker may be added to the earthen formation through a borehole, and only form the gel when activated by the slightly acidic conditions in situ.

### Water Concentration

In some embodiments, a solution of polymer(s) and crosslinker(s) in water may initially have a viscosity similar to that of water. A water-like viscosity may allow the solution to effectively penetrate voids, small pores, and crevices, such as encountered in fine sands, coarse silts, and other formations. In other embodiments, the viscosity may be varied to obtain a desired degree of flow sufficient for decreasing the flow of water through or increasing the load-bearing capacity of a formation. The viscosity of the solution may be varied by increasing or decreasing the amount of water relative to the crosslinking and polymers, by employing viscosifying agents, or by other techniques common in the art.

In some embodiments, the combined amount of polymers and crosslinkers may range from 0.5 to 100 weight percent, based upon the total weight of water in the solution. In other embodiments, the combined amount of polymers and crosslinkers may range from 5 to 100 weight percent, based upon the total weight of water in the solution; from 20 to 70 weight percent in other embodiments; from 25 to 65 weight percent in yet other embodiments. As used herein, total weight of water is exclusive of any additional water added with pH adjusting reagents.

The polymer and the crosslinker may react to form gel beads. For example, in some embodiments, bead formation may be effected by agitation of the solution. In other embodiments, bead formation may be effected by forming an emulsion or suspension of the reactants in water. In certain embodiments, an emulsion or suspension may be formed using an organic solvent, emulsifying agents, or combinations thereof.

### Hardness

The reaction of the polymer and the crosslinking agent may produce gels having a consistency ranging from a viscous sludge to a hard gel. In some embodiments, the reaction of the polymer and the crosslinking agent may result in a soft elastic gel. In other embodiments, the reaction may result in a good gel; in a hard gel in yet other embodiments. The hardness of the gel is the force necessary to break the gel structure, which may be quantified by measuring the force required for a needle to penetrate the crosslinked structure. Hardness is a measure of the ability of the gel to resist to an established degree the penetration of a test needle driven into the sample at a constant speed.

Hardness May be Measured by Using a Brookfield QTS-25 Texture Analysis Instrument. This instrument consists of a probe of changeable design that is connected to a load cell. The probe may be driven into a test sample at specific speeds or loads to measure the following parameters or properties of a sample: springiness, adhesiveness, curing, breaking strength, fracturability, peel strength, hardness, cohesiveness, relaxation, recovery, tensile strength burst point, and spreadability. The hardness may be measured by driving a 4 mm diameter, cylindrical, flat faced probe into the gel sample at a constant speed of 30 mm per minute. When the probe is in contact with the gel, a force is applied to the probe due to the resistance of the gel structure until it fails, which is recorded via the load cell and computer software. As the probe travels through the sample, the force on the probe is measured. The force on the probe may be recorded providing an indication of the gel's overall hardness. For example, the initial peak force may be recorded at the point the gel first fails, close to the first contact point, followed by recording highest and lowest values measured after this point where the probe is travelling through the bulk of the gel.

In some embodiments, the resulting gel may have a hardness value from 10 to 100000 gram-force. In other embodiments, the resulting gel may be a soft elastic gel having a hardness value in the range from 10 to 100 gram-force. In other embodiments, the resulting gel may be a firm gel having a hardness value from 100 to 500 gram-force. In other embodiments, the resulting gel may range from hard to tough, having a hardness value from 500 to 100,000 gram-force; from 1,500 to 75,000 gram-force in other embodiments; from 2,500 to 50,000 gram-force in yet other embodiments; from 5,000 to 30,000 gram-force in yet other embodiments.

In other embodiments, the hardness of the gel may vary with the depth of penetration. For example, the gel may have a hardness of 1,500 gram-force or greater at a penetration depth of 20 mm in some embodiments. In other embodiments, the gel may have a hardness of 5,000 gram-force or greater at a penetration depth of 20 mm; 15,000 gram-force or greater at a penetration depth of 20 mm in other embodiments; and 25,000 gram-force or greater at a penetration depth of 25 mm in yet other embodiments.

Gels useful in downhole applications may comprise gels with a hardness ranging from about 10 to 7,000 psi. In other embodiments, the gel may have a hardness ranging from about 100 to 5,000 psi, and from 300 to 2,000 psi in yet other embodiments.

With respect to the variables listed above (i.e. temperature, time, etc.), those having ordinary skill in light of the disclosure will appreciate that, by using the present disclosure as a guide, properties of the gel may be tailored as desired.

### Applications

Some embodiments of the gels or beads disclosed herein may be formed in a one-solution single component system, where the oxazoline crosslinking agent(s) are premixed with the polymer (material to be crosslinked). The mixture may then be placed or injected prior to cure. The gel times and bead formation times may be adjusted by adjusting the concentration of the solvent, reactants, and hardening agents, such as inorganic base or tertiary amine, in the solution.

Other embodiments of the gels and beads disclosed herein may also be formed in a two-component system, where the oxazoline crosslinking and polymers may be mixed separately and combined immediately prior to injection. In the case of a two-component system, the oxazoline crosslinking agent may be added neat, or in a solution of a solvent without polymer comprising an oxazoline reactive group. Alternatively, one reagent, the oxazoline crosslinking agent or polymer, may be placed in the wellbore or the near-wellbore region where it may then be contacted by the other reagent, either the oxazoline crosslinking agent or polymer as required. Gel times or bead formation times may be adjusted by varying the ratio of reactant, the concentration of tertiary amine catalyst, and quantity of solvent.

Embodiments of the gels disclosed herein may be used in applications including: as an additive in drilling muds, in particular water based muds, and as an additive in loss circulation material (LCM) pills; wellbore (WB) strengthening treatments. The gels disclosed herein may also find use in other downhole applications, such as insulating packer fluids and remediations for sustained casing pressure, where gel treatments may be typically used. Other applications include zonal isolation, water shut-off, fracturing, gravel packing, sand consolidation and finese fixation, heat activated swelling packers and casing repair. Moreover the gels disclosed herein may be used as insulating/compressible packer fluids, or coatings/gels for encapsulating active ingredients such as corrosion inhibitors, biocide defoamers and breakers.

### Use in Drilling Muds

The gels and beads disclosed herein may be used as an additive in drilling mud. Drilling fluids or muds typically include a base fluid (for example water, diesel or mineral oil, or a synthetic compound), weighting agents (for example, barium sulphate or barite may be used), bentonite clay, and various additives that serve specific functions, such as polymers, corrosion inhibitors, emulsifiers, and lubricants. A number of different muds exist, and limitations on the present disclosure is not intended by reference to particular types. During drilling, the mud is injected through the centre of the drill string to the drill bit and exits in the annulus between the drill string and the wellbore, fulfilling, in this manner, the cooling and lubrication of the bit, casing of the well, and transporting the drill cuttings to the surface. Gels and beads described by the procedures above may be included in a wellbore fluid. The wellbore fluids may include an oleaginous continuous phase, a non-oleaginous discontinuous phase, and a gel as disclosed herein. Gel and bead formulations described above may be modified in accordance with the desired application. For example, modifications may include the degree of crosslinking, and/or the nature of the polymer or oxazoline crosslinking agent.

The oleaginous fluid may be a liquid and more preferably is a natural or synthetic oil and more preferably the oleaginous fluid is selected from the group including diesel oil; mineral oil; a synthetic oil, such as hydrogenated and unhydrogenated olefins including polyalphaolefins, linear and branch olefins and the like, polydiorganosiloxanes, siloxanes, or organosiloxanes, esters of fatty acids, specifically straight chain, branched and cyclical alkyl ethers of fatty acids, mixtures thereof and similar compounds; and mixtures thereof. The concentration of the oleaginous fluid should be sufficient so that an invert emulsion forms and may be less than about 99% by volume of the invert emulsion. For example, the amount of oleaginous fluid is from about 30% to about 95% by volume and more preferably about 40% to about 90% by volume of the invert emulsion fluid. The oleaginous fluid may include at least 5% by volume of a material selected from the group including esters, ethers, acetals, dialkylcarbonates, hydrocarbons, and combinations thereof. The non-oleaginous fluid used in the formulation of the invert emulsion fluid disclosed herein is a liquid and preferably is an aqueous liquid. More preferably, the non-oleaginous liquid may be selected from the group including sea water, a brine containing organic and/or inorganic dissolved salts, liquids containing water-miscible organic compounds and combinations thereof. The amount of the non-oleaginous fluid is typically less than the theoretical limit needed for forming an invert emulsion. Thus the amount of non-oleaginous fluid is less than about 70% by volume and preferably from about 1% to about 70% by volume. In some embodiments, the non-oleaginous fluid is preferably from about 5% to about 60% by volume of the invert emulsion fluid. The fluid phase may include either an aqueous fluid or an oleaginous fluid, or mixtures thereof. In particular embodiments, coated barite or other weighting agents may be included in a wellbore fluid comprising an aqueous fluid that includes at least one of fresh water, sea water, brine, and combinations thereof. The fluids disclosed herein are especially useful in the drilling, completion and working over of subterranean oil and gas wells. In particular the fluids disclosed herein may find use in formulating drilling muds and completions fluids that allow for the easy and quick removal of the filter cake. Such muds and fluids are especially useful in the drilling of horizontal wells into hydrocarbon bearing formations.

Conventional methods can be used to prepare the drilling fluids disclosed herein in a manner analogous to those normally used, to prepare conventional drilling fluids. A desired quantity of oleaginous fluid such as a base oil and a suitable amount of the surfactant described above are mixed together and the remaining components are added sequentially with continuous mixing. An invert emulsion may be formed by vigorous agitating, mixing or shearing the oleaginous fluid and the non-oleaginous fluid.

Other additives that may be included in the wellbore fluids disclosed herein include for example, wetting agents, organophilic clays, viscosifiers, fluid loss control agents, surfactants, dispersants, interfacial tension reducers, pH buffers, mutual solvents, thinners, thinning agents and cleaning agents.

In some embodiments, the gels may form a filter cake or one component of a filter cake that forms along the wellbore as drilling progresses. The gels contained in the drilling fluid may be deposited along the wellbore throughout the drilling process, potentially strengthening the wellbore by stabilizing shale formations and other sections encountered while drilling. Improved wellbore stability may reduce the occurrence of stuck pipe, hole collapse, hole enlargement, lost circulation, and may improve well control. Wellbore stability may also be enhanced by the injection of a low viscosity mixture of a polymer and an oxazoline crosslinking agent into formations along the wellbore. The mixture may then continue to react, strengthening the formation along the wellbore upon gelation of the mixture. In other embodiments, the gels and beads disclosed herein may aid in lifting solid debris from tubing walls and through the tubing annulus. Hard gels and beads circulating through the drill pipe during drilling may scrape and clean the drill pipe, removing any pipe scale, mud, clay, or other agglomerations that may have adhered to the drill pipe or drill tubing. In this manner, the drill pipe may be maintained free of obstructions that could otherwise hinder removal of drilled solids from the drill pipe during drilling.

### Enhanced Oil Recovery

Embodiments of the gels disclosed herein may be used to enhance secondary oil recovery efforts. In secondary oil recovery, it is common to use an injection well to inject a treatment fluid, such as water or brine, downhole into an oil-producing formation to force oil toward a production well. Thief zones and other permeable strata may allow a high percentage of the injected fluid to pass through only a small percentage of the volume of the reservoir, for example, and may thus require an excessive amount of treatment fluid to displace a high percentage of crude oil from a reservoir.

To combat the thief zones or high permeability zones of a formation, embodiments of the gels and beads disclosed herein may be injected into the formation. Gels and beads injected into the formation may partially or wholly restrict flow through the highly conductive zones. In this manner, the gels and beads may effectively reduce channelling routes through the formation, forcing the treating fluid through less porous zones, and potentially decreasing the quantity of treating fluid required and increasing the oil recovery from the reservoir.

In other embodiments, gels and beads may also be formed in situ within the formation to combat the thief zones. Polymers may be injected into the formation, allowing the polymers to penetrate further into the formation than if a gel was injected. The crosslinking agents may then be injected, causing the previously injected polymers to crosslink within the formation. By forming the gels and beads in situ in the formation, it may be possible to avert channelling that may have otherwise occurred further into the formation, such as where the treatment fluid traverses back to the thief zone soon after bypassing the injected gels as described above.

### LCM Pills

As mentioned above, gels and beads disclosed herein may be used as one component in a drilling fluid. The gels and beads may form part of a filter cake, minimizing seepage of drilling fluids to underground formations and lining the wellbore. As another example, embodiments of the gels and beads disclosed herein may be used as one component in loss circulation material (LCM) pills that are used when excessive seepage or circulation loss problems are encountered, requiring a higher concentration of loss circulation additives. LCM pills are used to prevent or decrease loss of drilling fluids to porous underground formations encountered while drilling.

In some embodiments, the crosslinking agent and polymer/material may be mixed prior to injection of the pill into the drilled formation. The mixture may be injected while maintaining a low viscosity, prior to gel formation, such that the gel may be formed downhole. In other embodiments, the gelling material and crosslinking agent may be injected into the formation in separate shots, mixing and reacting to form a gel or bead in situ (in the formation following injection of the LCM pill shots). In this manner, premature gel or bead formation may be avoided.

For example, a first mixture containing a polymer may be injected into the wellbore and into the lost circulation zone. A second mixture containing a crosslinking agent and/or pH modifier may be injected, causing the polymer to crosslink in situ to the point that the gel expands in size. The expanded and hardened gel or bead may plug fissures and thief zones, closing off the lost circulation zone.

Embodiments of the present invention will now be described by way of example only.

Tests of Oxazoline Based Agents with Carboxy Methyl Cellulose (CMC)

### Method

A control example and an example in accordance with the present invention were prepared as outlined below. The samples of the two examples were placed in small, wide mouthed, plastic jars and aged in an oven at 120° F. (49° C.). pH was adjusted at various intervals with 5N HCl and changes in rheology were measured on a FANN Model 35 series viscometer.

### Control Sample

200 ml control based on 5% w/v solution of carboxy methyl cellulose (an extra low viscosity polymer sold under the name POLYPAC ELV by M-I Swaco.

TABLE 1

| | | | | | | | | 10 | |
|---|---|---|---|---|---|---|---|---|---|
| | | 600 | 300 | 200 | 100 | 6 | 3 | sec | |
| pH | Aging | rpm | rpm | rpm | rpm | rpm | rpm | gel | PV/YP |
| 8.2 | 25 | 101 | 50 | 39 | 21 | 3 | 2 | 3/— | 51/9 |
| | Mins | | | | | | | | |
| 6 | 20 | 99 | 54 | 38 | 21 | 4 | 2 | 3/— | 45/9 |
| | Hours | | | | | | | | |
| 3.3 | 72 | 93 | 53 | 38 | 22 | 4 | 2 | 3/— | 40/13 |
| | Hours | | | | | | | | |

As shown in table 1 the reduction in pH after an extended period of time makes a negligible difference to the viscosity of the control sample.

### EXAMPLE

200 ml Control (as above)+1 ml oxazoline crosslinker (sold under the brand name Epocros W700 by Nippon Shokubai (supra)).

TABLE 2

| | | | | | | | | 10 | |
|---|---|---|---|---|---|---|---|---|---|
| | | 600 | 300 | 200 | 100 | 6 | 3 | sec | |
| pH | Aging | rpm | rpm | rpm | rpm | rpm | rpm | gel | PV/YP |
| 8.2 | 25 | 100 | 55 | 39 | 21 | 3 | 2 | 3/— | 45/10 |
| | Mins | | | | | | | | |
| 6 | 20 | 92 | 50 | 36 | 20 | 4 | 2 | 3/— | 42/8 |
| | Hours | | | | | | | | |
| 3.4 | 72 | o/s | o/s | o/s | o/s | o/s | 80 | | |
| | Hours | | | | | | | | |

(o/s = off scale ie too viscous to measure)

In contrast to the control sample, table 2 shows that after an extended period of time and a reduction in pH, the viscosity of the sample increases dramatically—it is so viscous that it is off scale, and so has a viscosity of more than 300 on the dial reading.

An important aspect is the increased viscosity with a reduction in pH. Such embodiments are particularly suitable for use in downhole environments since they are normally slightly acidic, (often caused by the presence of carbon dioxide present). Thus the result that the gel's viscosity increases greatly when it encounters the conditions in an earthen formation is of great interest. This can be used to control the formation of the gel deep within the formation, which is otherwise difficult to do.

Moreover an unusual characteristic of oxazoline based agent is that it gives delayed crosslinking of the carboxylate group, and with CMC in particular the ability to get delayed/controllable cross linking of naturally based materials with low hazard chemicals compared to chromium & epichlorhydrin is very useful as it is less restricted not only from a performance perspective but also on health and safety grounds.

Tests of Oxazoline Based Agents with a Synthetic Acrylate Based Polymer; IDCAP D

A second control example and a second example in accordance with the present invention were prepared using a different polymer, in these examples, a synthetic acrylate based polymer, sold under the name IDCAP D by M-I Swaco was used. The samples of the two examples were placed in small, wide mouthed, plastic jars and aged in an oven at 120° F. (49° C.). pH was adjusted at various intervals with 5N HCl and changes in rheology were measured on a FANN Model 35 series viscometer.

### Control

200 ml Control based on 5% w/v solution of IDCAP D (initial natural pH 5.2)

TABLE 3

| | | | | | | | | 10 | |
|---|---|---|---|---|---|---|---|---|---|
| | | 600 | 300 | 200 | 100 | 6 | 3 | sec | |
| pH | Aging | rpm | rpm | rpm | rpm | rpm | rpm | gel | PV/YP |
| 5.2 | 25 | 149 | 83 | 58 | 31 | 4 | 3 | 3/— | 66/17 |
| | Mins | | | | | | | | |
| 5.4 | 20 | 118 | 64 | 45 | 24 | 3 | 2 | 3/— | 54/10 |
| | Hours | | | | | | | | |
| 4.9 | 72 | 80 | 43 | 30 | 16 | 3 | 2 | 3/— | 37/6 |
| | Hours | | | | | | | | |

As can be observed from table 3, there is no increase in viscosity over time and indeed a slight reduction in viscosity.

### 200 ml Control+1 ml Oxazoline Crosslinker (Epocros W700)

TABLE 4

| | | | | | | 10 | | | |
|---|---|---|---|---|---|---|---|---|---|
| 600 | 300 | 200 | 100 | 6 | 3 | sec | | | |
| rpm | rpm | rpm | rpm | rpm | rpm | gel | PV/YP | pH | Aging |
| 148 | 83 | 58 | 31 | 4 | 3 | 4/— | 65/18 | 5.2 | 25 |
| | | | | | | | | | Mins |
| 171 | 99 | 71 | 40 | 6 | 3 | 4/— | 72/27 | 5.5 | 20 |
| | | | | | | | | | Hours |
| 190 | 100 | 70 | 40 | 6 | 4 | 4/— | 90/10 | 4.9 | 72 |
| | | | | | | | | | Hours |

As shown in table 4, there is clear indication that the oxazoline crosslinker is reacting with the acrylate polymer. This signifies again that the level of crosslinking is dependent on the composition of the agent used and indicates that there are many variables that can be adjusted such as, the structure of the agent and the base polymer, and their concentrations in order to optimize the gel properties to match the application (water control, lost circulation for example) with the conditions that are to be encountered in use such as the differing reservoir temperatures and pH levels etc.

### Tests on Synthetic Acrylate Based Polymer (Idcap D) with Penkozil PZC, a Zr Based Crosslinkinq Agent

### Comparative Example

The above results can be compared with similar test results with a Zr crosslinking agent, table 5, which reacted too rapidly and gave instant crosslinking meaning that it would not be suitable for many downhole applications.

A 5%/w/v polymer solution was made up with an initial pH of 5.6, split into 200 ml aliquots and placed in sealed plastic pots. The Zr crosslinking agent was then added in 0.4, 0.8, 1.6 ml amounts respectively and the pot agitated.

The samples were then aged in an oven@120° F. (49° C.) and the rheological profile measured after 16 hours.

TABLE 5

| | | Zr | | Observations | | | | | | | | | |
|---|---|---|---|---|---|---|---|---|---|---|---|---|---|
| | | Crosslinker | Initial | on aging 16 hrs | | | | | | | | | |
| pH | Sample | (ml) | Observations | @ 120° F. | 120° F. Fann 35 Rheo | | | | | | Gels | PV | YP |
| 5.7 | 1 | 0.4 | Instant | Sep gel on | 132 | 72 | 50 | 27 | 3 | 2 | 2/— | 60 | 12 |
| | | | gelation, | surface | | | | | | | | | |
| 5.8 | 2 | 0.8 | lumps of | Sep gel on | 155 | 88 | 63 | 34 | 3 | 2 | 3/— | 67 | 21 |
| 6 | 3 | 1.6 | polymer, non- | surface, | 157 | 91 | 64 | 35 | 3 | 2 | 3/— | 66 | 25 |
| | | | homogenous | silversoned to | | | | | | | | | |
| | | | | homogenise | | | | | | | | | |

| | | | | | | | | | | |
|---|---|---|---|---|---|---|---|---|---|---|
| 5.6 | Control No crosslinker | 100 | 55 | 38 | 20 | 2 | 2 | 2/— | 45 | 10 |

Thus embodiments of the invention have been shown above to form gels suitable for use for a number of different applications in earthen formations, including but not limited to use in drilling muds, enhanced oil recovery and LCM pills. An important benefit of embodiments of the invention is their reduced toxicity compared to traditional gels for such use. Moreover particularly preferred embodiments are activated by the acidity typically found in earthen formations. This affords greater control of the reaction which reduces the likelihood of the gel forming too quickly and so being difficult to pump and/or being to viscous to penetrate deeply into the formation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method of treating an earthen formation comprising injecting gel components comprising at least one polymer, or polymer precursor, and at least one oxazoline crosslinking agent into a wellbore, wherein the at least one polymer, or polymer precursor, comprises a carboxyl group.

2. (canceled)

3. (canceled)

4. The method of claim 1, wherein the at least one polymer, or polymer precursor, is selected from dimer and trimer acid derivatives of starch, guar, soybean oil, linseed oil, rapeseed oil, cashew nut shell oil; perilla oil, tung oil, oiticia oil, safflower oil, poppy oil, hemp oil, cottonseed oil, sunflower oil, high-oleic triglycerides, triglycerides of euphorbia plants, peanut oil, olive oil, olive kernel oil, almond oil, kapok oil, hazelnut oil, apricot kernel oil, beechnut oil, lupine oil, maize oil, sesame oil, grapeseed oil, lallemantia oil, castor oil, herring oil, sardine oil, menhaden oil, whale oil, and tall oil.

5. The method of claim 1, wherein the oxazoline crosslinking agent is at least one of an aliphatic oxazoline crosslinking agent, an aromatic oxazoline crosslinking agent, and a cycloaliphatic oxazoline crosslinking agent.

6. The method of claim 1, wherein the oxazoline crosslinking agent is polyfunctional.

7. The method of claim 1, further comprising dissolving the at least one polymer, or polymer precursor, and at least one oxazoline crosslinking agent in a solvent prior to injecting.

8. The method as claimed in claim 7, wherein the oxazoline crosslinking agent is dissolved in a water-based solvent.

9. The method of claim 1, further comprising dispersing the at least one polymer, or polymer precursor, and at least one oxazoline crosslinking agent in a solvent to form an emulsion prior to injecting.

10. The method of claim 1, wherein a weight ratio of the polymer, or polymer precursor, to the oxazoline crosslinking agent ranges from about 2:1 to about 1:1.5.

11. The method of claim 1, wherein the volume percent of the oxazoline crosslinking agent relative to the total volume of the gel comprises approximately 10 to 40 percent.

12. The method of claim 1, wherein the polymer, or polymer precursor, and the oxazoline crosslinking agent are injected simultaneously.

13. The method of claim 1, wherein the polymer, or polymer precursor, and the oxazoline crosslinking agent are injected sequentially.

14. (canceled)

15. The method of claim 1, wherein the gel components react at a pH of less than 7.

16. (canceled)

17. The method of claim 1, wherein the reaction of the gel components is activated by the acidity of the earthen formation.

18. The method of claim 1, wherein the reaction of the gel components is activated by organic acids present in the earthen formation.

19. A gel for use in downhole applications comprising the reaction product of at least one polymer, or polymer precursor, and at least one oxazoline crosslinking agent, wherein the at least one polymer, or polymer precursor, is selected from oligomers and polymers thereof of acrylates, cellulose starch, guar and biopolymers or derivatives thereof.

20. A gel as claimed in claim 19, wherein the at least one polymer, or polymer precursor, and the oxazoline crosslinking agent are combined in a solution.

21. (canceled)

22. (canceled)

23. The gel of claim 19, wherein the at least one polymer, or polymer precursor, is selected from dimer and trimer acid derivatives of starch, guar, soybean oil, linseed oil, rapeseed oil, cashew nut shell oil; perilla oil, tung oil, oiticia oil, safflower oil, poppy oil, hemp oil, cottonseed oil, sunflower oil, high-oleic triglycerides, triglycerides of euphorbia plants, peanut oil, olive oil, olive kernel oil, almond oil, kapok oil, hazelnut oil, apricot kernel oil, beechnut oil, lupine oil, maize oil, sesame oil, grapeseed oil, lallemantia oil, castor oil, herring oil, sardine oil, menhaden oil, whale oil, and tall oil.

24. The gel of claim 19, wherein the oxazoline crosslinking agent is at least one of an aliphatic oxazoline crosslinking agent, an aromatic oxazoline crosslinking agent, and cycloaliphatic oxazoline crosslinking agents.

25. The gel of claim 19, wherein the oxazoline crosslinking agent is polyfunctional.

26. The gel of claim 19, wherein the oxazoline crosslinking agent is dissolved in a water-based solvent.

27. (canceled)

28. The gel of claim 19, wherein a weight ratio of the polymer, or polymer precursor, to the oxazoline crosslinking agent ranges from about 2:1 to about 1:1.5.

29. The gel of claim 19, wherein the volume percent of the oxazoline crosslinking agent relative to the total volume of the gel comprises approximately 10 to 40 percent.

30. A method of treating an earthen formation comprising:
injecting polymer beads comprising the reaction product of a gel, wherein the gel comprises the reaction product of at least one polymer, or polymer precursor, and at least one oxazoline crosslinking agent, wherein the at least one polymer, or polymer precursor, is selected from oligomers and polymers thereof of acrylates, cellulose starch, guar and biopolymers or derivatives thereof; and
allowing the polymer beads to swell in the earthen formation.

31. (canceled)

32. (canceled)

33. (canceled)
